(19) United States
(12) Patent Application Publication
(10) Pub. No.: US 2006/0184402 A1
(43) Pub. Date: Aug. 17, 2006

(54) Hospitality Analytics

(75) Inventor: Bill A. Fuchs, Alamo, CA (US)

Correspondence Address: INTEGRITY LLC;BILL FUCHS, 2951 ROUNDHILL ROAD, ALAMO, CA, 94507, US

(73) Assignee: Bill A. Fuchs, Alamo, CA (US)

(21) Appl. No.: 11/164,844

(22) Filed: Dec. 7, 2005

(51) Int. Cl. G06F 9/44; G05B 19/418

(52) U.S. Cl. 705/7; 705/8

(57) ABSTRACT

Hospitality Analytics is an advanced suite of interactive analysis tools developed to thoroughly analyze any hospitality environment. Analysis is of both physical and virtual workspaces and their interrelationship with each other. The tool suite allows for design and implementation to be correct by construction.

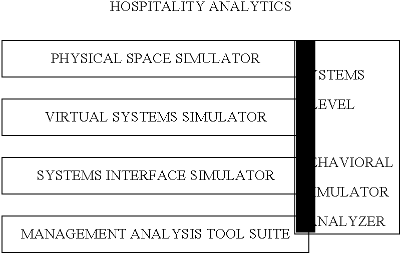

Hospitality Analytics is an advanced suite of interactive analysis tools developed to thoroughly analyze any hospitality environment.

Analysis is of both physical and virtual workspaces and their interrelationship with each other.

What is claimed is:

1. Hospitality Analytics can via precision simulation, map a physical area and interpret its use, plan, functionality, viability and usability for its planned use purpose.

2. The virtual workflow simulator enables analysis of electronic systems using time and work loading to develop a precision analysis prior to system build, this enables a hotel developer to design better systems to manage and operate their business based upon accurate use prediction modeling.

3. Hospitality Analytics precision simulator suite can address issues from; architectural layout for physical traffic flow of vehicles or personnel through open spaces, in addition to systems types and personnel interaction with systems to determine load capacity, loading effect and overall system reliability and performance, basically the Hospitality Analytics tool suite affords a better implementation and build-out for hospitality environments and large scale public areas.

4. The simulators can be loaded with data variables to test different event scenarios, thereby deriving accurate prediction models, each simulator can be driven by rules such as building codes and ordinances for the given municipality.

5. The simulators will afford designers, engineers and architects precise trade-off criteria for accurate modeling and correct-by-construction design, it is always best to know areas of concern before construction.
